(19) United States
(12) Patent Application Publication
(10) Pub. No.: US 2006/0072591 A1
(43) Pub. Date: Apr. 6, 2006

(54) Initiation of call forwarding for wireless telephone

(76) Inventors: Gary Rogalski, Richmond (CA); Holger Janssen, Richmond (CA)

Correspondence Address: SHAW PITTMAN LLP, 1650 Tysons Boulevard, McLean, VA, 22102, US

(21) Appl. No.: 10/948,171

(22) Filed: Sep. 24, 2004

(51) Int. Cl. H04L 12/56

(52) U.S. Cl. 370/401

(57) ABSTRACT

Methods and systems for forwarding calls associated with a first telephone to a second telephone are disclosed. In an exemplary embodiment of the invention, one of the first telephone and the second telephone is configured to send an instruction to a first telephone network associated with the first telephone to forward calls intended for the first telephone to a destination telephone associated with a telephone network different from the first telephone network. Preferably, the second telephone is associated with a public switched telephone network. Preferably, the destination telephone is the second telephone. A processor associated with one of the first telephone and the second telephone is configured to sense the presence of the first telephone within the vicinity of the second telephone. When the first telephone is within the vicinity, the processor sends the instruction.

### BACKGROUND

1. Field of the Invention

The present invention relates generally to telephone call routing and, more particularly, to call forwarding from a first telephone system to a second telephone system.

2. Background of the Invention

Many users prefer to receive telephone calls on their home line (wireline) rather than on their cellular or wireless line while they are at home. Reasons for this preference include, for example, (1) voice quality of the home line is superior to that of the cellular line, (2) charges for local calls on the cellular line can be avoided, and (3) better ergonomics and voice quality of traditional home line telephones.

Currently, to forward incoming cellular telephone calls to his home line, a user needs to execute a sequence of key-presses on his cellular telephone. The user needs to perform this repetitive task every time he comes home to forward his wireless calls to his home line. When he forgets to key in the sequence, calls are not forwarded. Similarly, if the user forgets to deactivate the call forwarding by entering another sequence, when he leaves home with the cellular telephone, calls continue to be forwarded to his home line telephone, resulting in his inability to answer calls on his cellular telephone.

### SUMMARY OF THE INVENTION

The present invention provides systems and methods that forward telephone calls intended for a first telephone line to a destination telephone line that is different from the first telephone line. An exemplary implementation of the invention involves forwarding calls associated with a wireless telephone to a wireline telephone.

One embodiment of the invention provides a method that includes two steps. First, the presence of a first telephone associated with a first telephone line is sensed or detected within a vicinity of a second telephone associated with a second telephone line. The vicinity can be an RF range or a physical connection. Second, an instruction is transmitted or sent to a telephone network associated with the first telephone line. The instruction provides that calls intended for the first telephone line are to be forwarded to the destination telephone line. Preferably, the destination telephone line is the second telephone line. However, in another implementation, the destination telephone line is a third telephone line. The first telephone can be configured to perform one or both of the sensing step and the sending step. Similarly, the second telephone can be configured to perform one or both of the sensing step and the sending step.

The method can further be configured to include additional steps. For example, a third step can involve detection of an incoming call intended for the first telephone at the first telephone line. A fourth step can involve forwarding the incoming call to a destination telephone associated with the destination telephone line.

Preferably, the first telephone line is a wireless telephone line. Preferably, the second telephone line is a Public Switched Telephone Network (PSTN) telephone line. The destination telephone line can be another PSTN telephone line or another wireless telephone line.

Another embodiment of the invention provides a system for forwarding calls intended for a first telephone line to a destination telephone line. The system includes a sensing circuit and an instruction circuit. The sensing circuit is configured to detect or sense the presence of a first telephone associated with the first telephone line within a vicinity of a second telephone associated with a second telephone. The vicinity can be an RF range or a physical connection. The instruction circuit is configured to send an instruction to a telephone network associated with the first telephone to forward calls intended for the first telephone to a destination telephone associated with the destination telephone line. Preferably, the system further includes a cradle associated with the second telephone for receiving the first telephone. The first telephone line is preferably a wireless telephone line. The second telephone line is preferably a PSTN telephone line. The destination telephone line can be the second telephone line or another telephone line, which can be a wireless telephone line or a PSTN telephone line. The sensing circuit can be associated with the first telephone or the second telephone. Similarly, the instruction circuit can be associated with the first telephone or the second telephone.

Preferably, one of the first telephone and the second telephone further includes a deactivation button that can be operated or otherwise manipulated manually when the first telephone is moved outside of the vicinity of the second telephone. This manual deactivation button may be required by some implementation because the sensing circuit and the instruction circuit can no longer communicate after the first telephone has been moved out of range of the second telephone. Such manual instruction is then necessary to cancel the forwarding of calls. This is particularly important because deactivation of call forwarding cannot be automated if the sensing circuit is implemented in one telephone and if the instruction circuit is implemented in the other telephone.

Another embodiment of the invention provides a method for forwarding telephone calls intended for a wireless telephone line to a PSTN telephone. First, the PSTN telephone detects the presence of the wireless telephone within a vicinity of the PSTN telephone. The vicinity can be an RF range or a physical connection. Next, the PSTN telephone sends an instruction to a wireless telephone network associated with the wireless telephone to forward calls intended for the wireless telephone to the PSTN telephone. When a call intended for the wireless telephone is received or detected by the wireless telephone network, the call is forwarded by the wireless telephone network to the PSTN telephone. Preferably, each of the wireless telephone and the PSTN telephone includes a BLUETOOTH transceiver.

Another embodiment of the invention provides a telephone associated with a first telephone network, which includes a sensor configured to detect presence of a wireless telephone within a vicinity of the telephone and a circuit configured to send an instruction to a wireless telephone network associated with the wireless telephone to forward calls intended for the wireless telephone to a destination telephone. The destination telephone may be associated with the first telephone network or another network. The vicinity can be an RF range or a physical connection. Preferably, the telephone includes a cradle configured to receive the wireless telephone. Preferably, the sensor is triggered when the wireless telephone is received in the cradle.

Another exemplary embodiment of the invention is a cordless telephone that includes a base unit, a portable unit (handset or headset), a sensor for detection of the presence of a wireless telephone, and an instruction circuit. The base unit is connected to a PSTN telephone line. The portable unit is in communication with the base unit. The sensor is configured to detect the presence of the wireless telephone associated with a wireless telephone network within a range of the cordless telephone. The sensor can be housed within the base unit or the portable unit. The circuit is configured to send an instruction to the wireless telephone network to forward calls intended for the wireless telephone to the cordless telephone.

Preferably, the base unit further includes a cradle configured to receive one of the portable unit and the wireless telephone. Alternatively, the base unit can include a first cradle configured to receive the portable unit and a second cradle configured to receive the wireless telephone. The instruction circuit is activated to send the instruction when the wireless telephone is received in a cradle of the base unit.

Another embodiment of the invention provides a system that forwards calls intended for a first telephone to a second telephone. One of the first telephone and the second telephone includes a processor. The processor is configured to send an instruction to a first telephone network associated with the first telephone to forward calls intended for the first telephone to a destination telephone associated with a telephone network different from the first telephone network. Preferably, the second telephone is associated with a public switched telephone network. Preferably, the destination telephone is the second telephone. However, the destination telephone may be a different telephone. Preferably, the second telephone further includes an activation switch. The activation switch is configured to be manually activated by a user of the second telephone to trigger the processor to send the instruction. Preferably, the processor is further configured to sense the presence of the first telephone within the vicinity of the second telephone. The vicinity can be defined by an RF range or by a physical connection between the first telephone and the second telephone. When the first telephone is within the vicinity, the processor sends the instruction.

Another embodiment of the invention is a method for processing telephone calls. One of the wireless telephone and the PSTN telephone sends a first instruction to a wireless telephone network associated with the wireless telephone to forward calls intended for the wireless telephone to the PSTN telephone. Then, the wireless telephone network telephone terminates a call intended for the wireless telephone at the public switched telephone network telephone. When a user decides to cancel the first instruction, the user may, for example, presses a button on the PSTN telephone to close a deactivation switch. Such user intervention is received by the PSTN telephone, which then conveys the user intervention to the wireless telephone. Such user intervention is needed because once the wireless telephone is out of the range of the PSTN telephone, deactivation of call forwarding cannot be automated. Then, the wireless telephone sends a second instruction to the wireless telephone network to cancel the first instruction. Subsequently, all subsequent calls intended for the wireless telephone are terminated to the wireless telephone.

Preferably, prior to the sending of the first instruction, one of the wireless telephone and the telephone detects the presence of the wireless telephone within a vicinity of the PSTN telephone. The vicinity is one of an RF range and a physical connection. For example, BLUETOOTH transceivers in the wireless telephone and the PSTN telephone establish wireless communication with each other when they are within the BLUETOOTH RF range. Alternatively, the physical connection, e.g., an electrical connection is made when the wireless telephone is placed within a cradle of, or otherwise connected to, the PSTN telephone.

### BRIEF DESCRIPTION OF THE DRAWINGS

FIG. 1 is a schematic diagram showing an exemplary system of the invention.

FIG. 2 is a flowchart showing exemplary steps that can be implemented to use a method of the invention.

FIG. 3 is a schematic diagram showing another exemplary system of the invention.

FIG. 4 is a schematic diagram showing another exemplary system of the invention.

FIG. 5 is a flowchart showing exemplary steps that can be implemented to use another method of the invention.

### DETAILED DESCRIPTION OF THE INVENTION

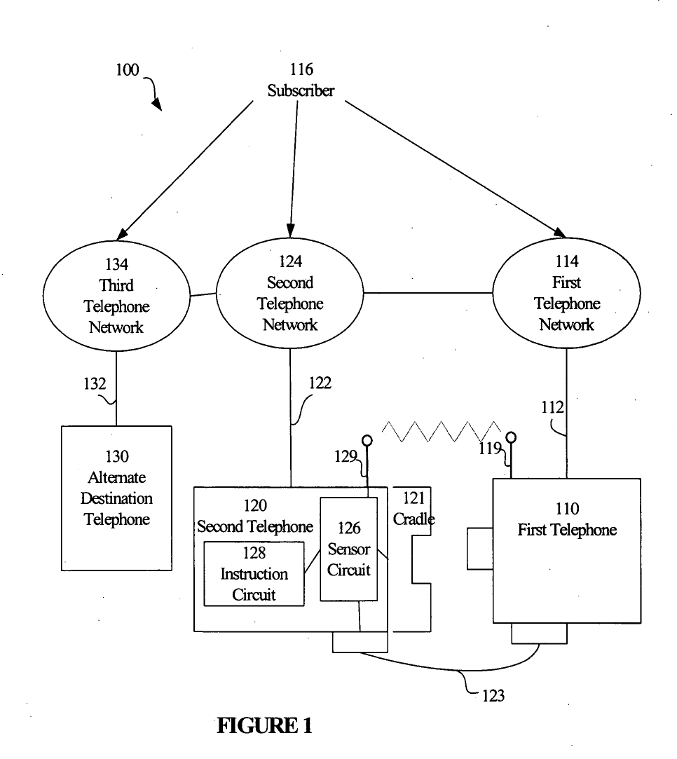

FIG. 1 is a schematic diagram showing an exemplary system of the invention. System 100 includes second telephone 120, which is a preferred embodiment of the invention. Second telephone 120 is configured to communicate with second telephone network 124 via second telephone line 122. Preferably, second telephone 120 is a wireline telephone and second telephone network 124 is the Public Switched Telephone Network (PSTN).

First telephone 110 is preferably a wireless telephone, which is associated with wireless telephone line 112 of first telephone network 114. First telephone 110 is associated with subscriber 116. Subscriber 116 is a customer of first telephone network 114. Subscriber 116 may also be a customer of one or more of second telephone network 124 and third telephone network 134. For example, second telephone 120 and alternate destination telephone 130 may be located within the home and/or office of subscriber 116. Alternate destination telephone 130 is connected to third telephone network 134 by telephone line 132.

Second telephone 120 includes sensor circuit 126 and instruction circuit 128. Sensor 126 is configured to sense the presence of first telephone 110 within the vicinity of second telephone 120. The presence of first telephone 110 can be sensed by sensor circuit 126 in one of several ways.

First, sensor circuit 126 can be configured to determine whether a signal transmitted by first telephone 110 can be detected with an RF range associated with second telephone 120. For example, in one specific implementation, first telephone 110 includes BLUETOOTH transceiver 119 and second telephone 120 includes BLUETOOTH transceiver 129. In this example, when first telephone 110 and second telephone 120 establish wireless communication via known BLUETOOTH protocols, the presence of first telephone 110 is detected by second telephone 120. Other RF technology may be used to detect the presence of first telephone 110 within the vicinity of second telephone 120.

Another way to detect the presence of first telephone 110 in the vicinity of second telephone 120 is by using a physical connection. For example, cable 123 can be used to establish electrical connection between first telephone 110 and second telephone 120. Preferably, however, second telephone 120 can be configured to include cradle 121 to receive first telephone 110. Cradle 121 includes electrical contacts that are in communication with sensor circuit 126. Preferably, electrical contacts of cradle 121 can also be used to supply power to charge a battery of first telephone 110.

Once the presence of first telephone 110 within the vicinity of second telephone 120 is detected by sensor circuit 126, instruction circuit 128, which is in communication with sensor circuit 126, sends an instruction to first telephone network 114 via second telephone network 124. Instruction circuit 128 can be, for example, configured to dial a designated telephone number to reach first telephone network 114. The instruction provides that all calls intended for first telephone 110 should be forwarded to a destination telephone. For example, the destination telephone can be second telephone 120. However, the destination telephone may be a telephone other than second telephone 120. For example, alternate destination telephone 130 may be the destination telephone. Third telephone network 134 may be a wireline network or wireless network.

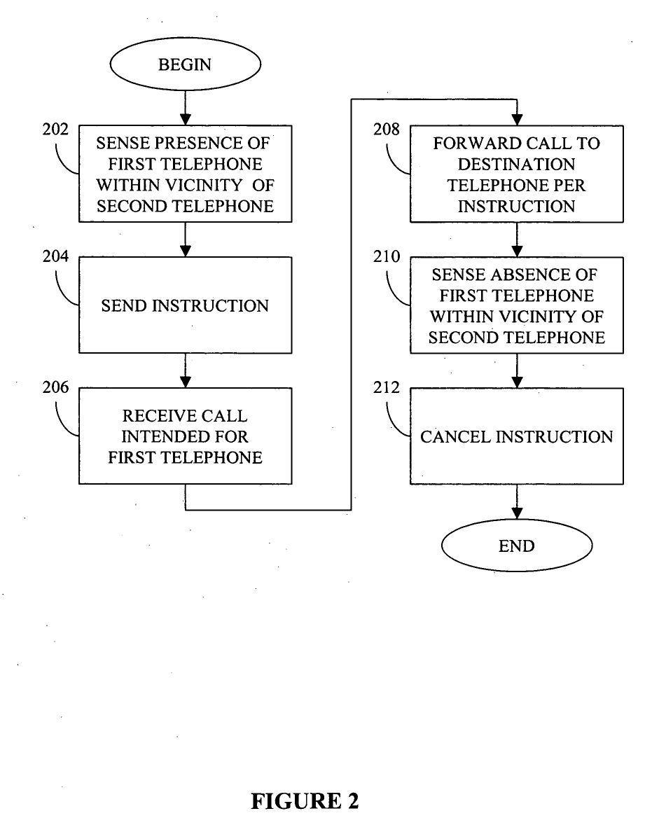

FIG. 2 is a flowchart showing exemplary steps that can be implemented to use a method of the invention. For convenience, references are made to features of FIG. 1 to aid understanding of the invention.

In step 202, the presence of first telephone 110 associated with first telephone line 112 is sensed or detected within a vicinity of second telephone 120 associated with second telephone line 122. The vicinity can be an RF range (e.g., BLUETOOTH or another technology) or a physical connection (e.g., via cable 123, cradle 121, or other means). The detection can be done, for example, by sensor circuit 126 of second telephone 120. Although sensor circuit 126 is shown in FIG. 1 to be a component of second telephone 120, sensor circuit 126 can be a component of first telephone 110 in another embodiment.

In step 204, an instruction is transmitted or sent by instruction circuit 128 to first telephone network 114 associated with first telephone line 110. Although instruction circuit 128 is shown in FIG. 1 to be a component of second telephone 120, instruction circuit 128 can be a component of first telephone 10 in another embodiment. The instruction provides that calls intended for first telephone line 112 are to be forwarded to destination telephone line 122, which is different from first telephone line 112. In another implementation, the destination telephone line is third telephone line 132, which is different from both first telephone line 112 and second telephone line 122.

Although shown as two separate components, sensor circuit 126 and instruction circuit 128 can be an integrated component.

The method can further be configured to include additional steps.

In step 206, an incoming call intended for first telephone 110 at first telephone line 112 is detected or received by first telephone network 114.

In step 208, consistent with the instruction of step 204, the incoming call is forwarded by first telephone network 114 to a destination telephone. The destination telephone can be one of both of second telephone 120 and third telephone 130. Indeed, it is within the contemplation of the inventors that the destination telephone can be any telephone other than first telephone 110.

Another embodiment of the invention includes additional steps. For example, in step 210, when first telephone 110 is out of the vicinity of second telephone 120 (e.g., out of cradle 121 or beyond the RF range of second telephone 120), the absence of first telephone 110 in the vicinity of second telephone 120 is detected by sensor circuit 126.

In step 212, instruction circuit 128 sends a second instruction to first telephone network to cancel the previous instruction. As a result, subsequent incoming calls intended for first telephone 110 would be forwarded to first telephone 110 and not any destination telephone.

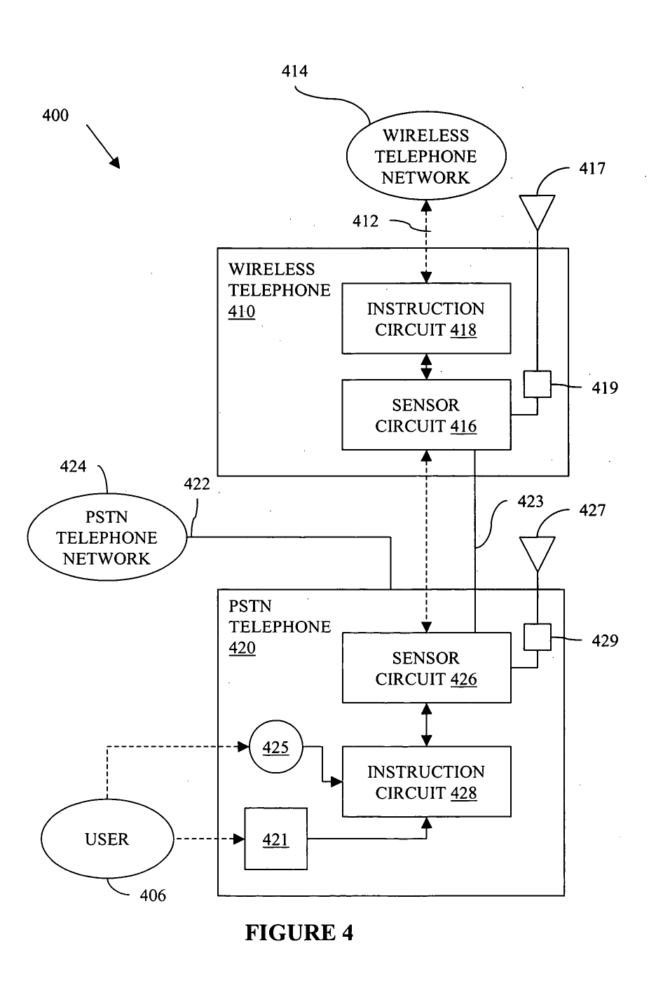

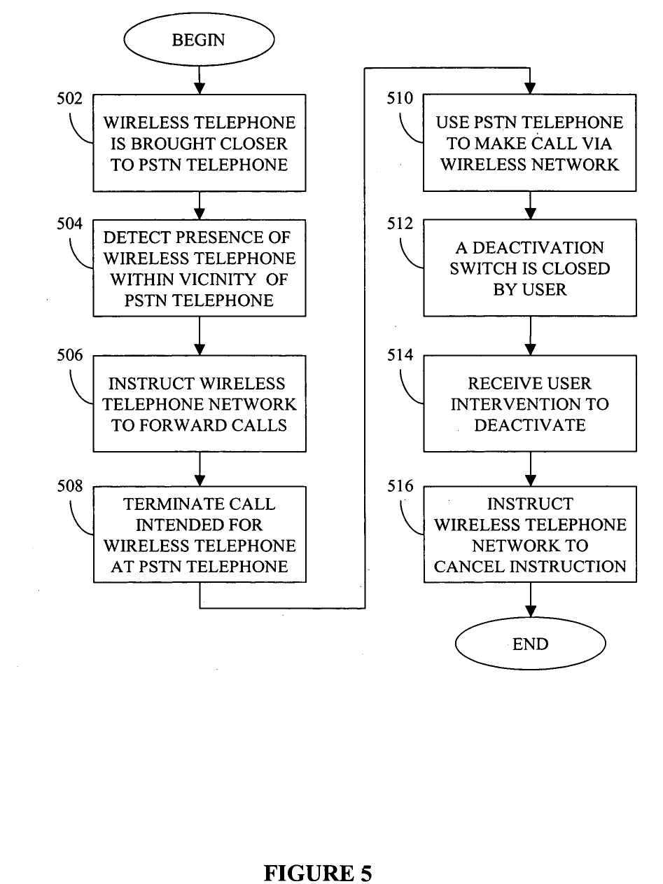

In another embodiment depicted in FIGS. 4 and 5 and described below, a deactivation switch is used to cancel the previous instruction.

Another exemplary embodiment of the invention is a cordless telephone that includes a base unit, one or more portable units (handsets or headsets), a sensor for detection of the presence of a wireless telephone, and an instruction circuit. The base unit is connected to a PSTN telephone line. The portable unit is in communication with the base unit. The sensor is configured to detect the presence of the wireless telephone associated with a wireless telephone network within a range of the cordless telephone. The sensor can be housed within the base unit or the portable unit. The circuit is configured to send an instruction to the wireless telephone network to forward calls intended for the wireless telephone to the cordless telephone. The circuit can be housed within the base unit or the portable unit.

Preferably, the base unit further includes a cradle configured to receive one of the portable unit and the wireless telephone. Alternatively, the base unit can include a first cradle configured to receive the portable unit and a second cradle configured to receive the wireless telephone. Preferably, the instruction circuit is activated to send the instruction when the wireless telephone is received in a cradle of the base unit.

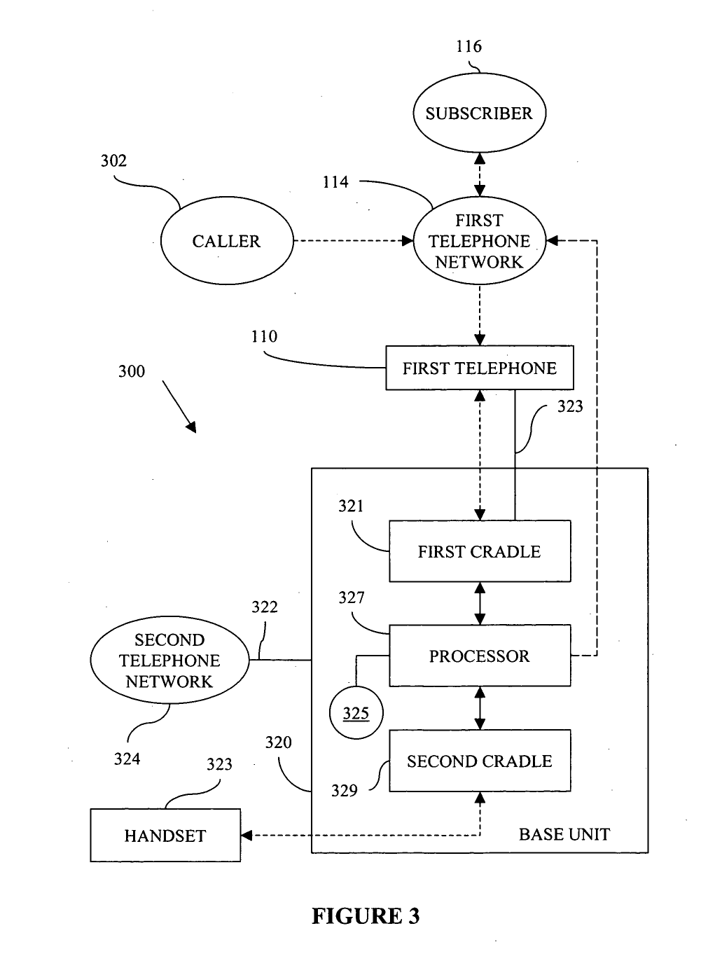

FIG. 3 is a schematic diagram showing another exemplary system of the invention.

Telephone 300 of the invention includes base unit 320 and portable unit 323. Portable unit 323 can be one or more of handsets and headsets. Base unit 320 and portable unit 323 communicate via known cordless telephone technology. Telephone 300 is connected to second telephone network 324 via telephone line 322. Telephone 300 is associated with subscriber 116. Although depicted in FIG. 3 and described herein as a cordless telephone system, telephone 300 can be a corded telephone as well.

Telephone 300 includes processor 327. Although depicted as an integrated component, processor 327 can include separate sensing and instruction circuits as described above and depicted in FIG. 1.

In this exemplary embodiment, first cradle 321 of base unit 320 is configured to receive first telephone 110. First telephone 110 is preferably a wireless telephone associated with first telephone network 114. First cradle 321 includes electrical contacts that are in communication with processor 327 to indicate the presence of first telephone 110 within first cradle 321. First cradle 321 can be further configured to supply electrical power to charge a battery of first telephone 110. As an alternative to first cradle 321, processor 327 can be configured to sense the presence of first telephone 110 using cable 323. As another alternative, wireless technology can be employed. For example, known BLUETOOTH protocols may be used by telephone 300 to sense the presence of first telephone 110 in the vicinity of telephone 300.

Preferably, base unit further includes second cradle 329. Second cradle 329 is configured to receive portable unit 323. As known in the art, second cradle 329 can be configured to include electrical contacts to supply power to charge a battery of portable unit 323. In addition, second cradle 329 can be configured to be in communication with processor 327 so that information can be transferred from first cradle to second cradle 329.

According to a preferred embodiment of the invention, subscriber 116 is a customer of both first telephone network 114 and second telephone network 124. Subscriber 116 can activate a call forwarding feature of telephone 300 by performing one or more of the following.

First, as disclosed above, when first telephone 110 is placed within the vicinity of base unit 320, processor 327 senses the presence and sends an instruction to first telephone network to forward calls intended for first telephone 110 to telephone 300 via telephone line 122.

Second, regardless of whether first telephone is within the vicinity of the base unit 320, subscriber 116 can activate processor 327 to send the instruction by activation switch 325, which is in communication with processor 327. In other words, in an alternative embodiment, when switch 325 is activated (i.e., closing of circuit), processor 327 sends an instruction to first telephone network 114 to forward calls intended for first telephone 110 to telephone 300.

FIG. 4 is a schematic diagram showing another exemplary system of the invention. System 400 includes PSTN telephone 420 of the invention. PSTN telephone 420 can be a corded or cordless telephone. PSTN telephone 420 is configured to communicate with PSTN 424 via PSTN telephone line 422.

Wireless telephone 410 is associated with wireless telephone line 412 of wireless telephone network 414. Wireless telephone 410 is associated with user 406. User 406 can be a customer of one of both of PSTN 424 and wireless telephone network 414. PSTN telephone 420 may be located within the home or office of user 406.

In FIG. 4, sensor circuit 416 and instruction circuit 418 are shown to be components of wireless telephone 410 and sensor circuit 426 and instruction circuit 428 are shown to be components of PSTN telephone 420. As described above, only one sensor circuit and one instruction circuit are sufficient to implement the present invention. Sensors 416 and 426 are configured to sense the presence of wireless telephone 410 within a vicinity of PSTN telephone 420. The presence of wireless telephone 410 within the vicinity can be sensed by sensor circuit 416 or sensor circuit 426, or both, in one of several ways.

For example, sensor circuit 426 can be configured to determine whether an RF signal transmitted by wireless telephone 410 can be detected with an RF range associated with PSTN telephone 420. For example, in one specific implementation, wireless telephone 410 includes BLUETOOTH transceiver 419 (and antenna 417) and PSTN telephone 420 includes BLUETOOTH transceiver 429 (and antenna 427). In this example, when wireless telephone 410 is brought by user 406 closer to PSTN telephone 420, a wireless communication is established via known BLUETOOTH protocols, and the presence of wireless telephone 410 within the vicinity of PSTN telephone 420 is detected by sensor circuit 426. Other RF technology may be used to detect the presence of wireless telephone 410 within the vicinity of PSTN telephone 420. Sensor circuit 416 in wireless telephone 410 can be configured to perform the same function.

Another way to detect the presence of wireless telephone 410 in the vicinity of PSTN telephone 420 is by using a physical connection. For example, electrical connection 423 can be used to establish contact between wireless telephone 410 and PSTN telephone 420. PSTN telephone 420 can be further configured to include a cradle to receive wireless telephone 410. Alternatively, other means, including a cable, can be used to connect wireless telephone 410 to PSTN telephone 420. The cable includes electrical contacts that are in communication with one or both of sensor circuit 416 and sensor circuit 426. Preferably, The cable can be used to supply power from an AC source connected to PSTN telephone 420 to charge a battery of wireless telephone 410.

In one implementation, once the presence of wireless telephone 410 within the vicinity of PSTN telephone 420 is detected by sensor circuit 426, instruction circuit 428, which is in communication with sensor circuit 426, sends a first instruction to wireless telephone network 414. The first instruction provides that all calls intended for wireless telephone 410 should be forwarded to PSTN telephone 420. In this implementation, instruction circuit 428 is configured to dial a designated telephone number to reach wireless telephone network 414.

In another implementation, when the presence of PSTN telephone 420 within the vicinity of wireless telephone 410 is detected by sensor circuit 416, instruction circuit 418, which is in communication with sensor circuit 416, sends the first instruction to wireless telephone network 414. The first instruction provides that all calls intended for wireless telephone 410 should be forwarded to PSTN telephone 420. In this implementation, instruction circuit 418 is configured to send the instruction using known wireless telephone technology.

It is further contemplated that another aspect of the invention includes activation switch 425, similar to activation switch 325 described above. In this aspect of the invention, the “presence” of wireless telephone within the vicinity is not required. For example, if user 406 had forgotten to bring home wireless telephone 410 or lost wireless telephone 410, user 406 may press activation switch 425 to send the first instruction.

Preferably, PSTN telephone 420 includes deactivation switch 421. Deactivation switch 421 may be a hard key on the base of telephone 420 or it may be a LCD menu item on the base or on the handset of telephone 421. As depicted in FIG. 4, deactivation switch 421 is to be in direct communication with instruction circuit 428. It can, however, be connected to instruction circuit 428 via sensor circuit 426. Deactivation switch 421 is configured to receive an user intervention. For example, when user 406 wishes to cancel call forwarding, user 406 can press a button (not shown) on PSTN telephone 420 that closes switch 421. Once activation/deactivation switch 421 is closed, instruction circuit 428 sends a second instruction to wireless telephone network 414 to cancel the first instruction.

Preferably, the user intervention (closing of deactivation switch 421) is conveyed to instruction circuit 418. This can be done by, for example, instruction circuit 428 via connection 423. Instruction circuit 418 then communicate with wireless telephone network 414 to send the second instruction.

Upon receipt of the second instruction, wireless telephone network 414 cancels the first instruction, and all subsequent calls intended for wireless telephone 410 is terminated to wireless telephone 410, and not PSTN telephone 420.

FIG. 5 is a flowchart showing exemplary steps that can be implemented to use a method of the invention. For convenience, references are made to features of FIG. 4 to aid understanding of the invention. The flowchart explains the steps involves in using a preferred embodiment of the invention.

In step 502, user 406 brings wireless telephone 410 closer to PSTN telephone 420. For example, wireless telephone 410 is held by user 406 as the user enters him home in which PSTN telephone 420 is present.

In step 504, when the wireless telephone 410 is brought to be within the vicinity of PSTN telephone 420, its presence is detected. The detection, as explained above, can be implemented using RF communication (e.g., via BLUETOOTH transceivers 419 and 429, or means) or a physical connection (e.g., via connection 423, or other means). The detection can be performed by, for example, sensor circuit 426 of PSTN telephone 420 or sensor circuit 416 of wireless telephone 410, or both.

In step 506, a first instruction is transmitted or sent by one of instruction circuit 418 and instruction circuit 428 to wireless telephone network 414. The instruction provides that calls intended for wireless telephone 410 are to be forwarded to PSTN telephone 420. As mentioned above, although shown as two separate components, the sensor circuit and the instruction circuit can be an integrated component, which can be in either PSTN telephone 420 or wireless telephone 410.

It is noted that another aspect of the invention involves user 406 closing activation switch in lieu of steps 502-506 described above.

In step 508, an incoming call intended for wireless telephone 410 is terminated at PSTN telephone 420 in accordance with the first instruction.

In step 510, an optional step, user 406 may use PSTN telephone 410 to make calls via wireless telephone network 414. This can be accomplished, for example, transferring the digits dialed on PSTN telephone 420 to make calls via wireless telephone network 414.

In step 512, when user 406 decides to cancel the first instruction, i.e., user 406 wishes to bring wireless telephone 410 away from home and to receive all calls intended for wireless telephone 410 at wireless telephone 410, user 406 presses a button to close deactivation switch 421.

In step 514, the user intervention (pressing the button to close deactivation switch 421) is received. The user intervention is conveyed to one of instruction circuit 418 and instruction circuit 428.

In step 516, one of instruction circuit 418 and instruction circuit 428 sends a second instruction to wireless telephone network 414 to cancel the first instruction. As a result, subsequent incoming calls intended for wireless telephone 110 would be forwarded to wireless telephone 410 and not PSTN telephone 420.

Preferably, in the above described steps, it is instruction circuit 418 that sends the first and second instructions. This can be easily implemented using existing wireless telephone technology. The use of instruction circuit 428, however, involves communication with wireless telephone network 414 via PSTN 424, which requires PSTN telephone 420 to use PSTN telephone line 422 to send the first and second instructions to wireless telephone network 414.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for forwarding telephone calls intended for a first telephone line to a destination telephone line that is different from the first telephone line, comprising:
sensing presence of a first telephone associated with the first telephone line within a vicinity of a second telephone associated with a second telephone line, wherein the vicinity is one of an RF range and a physical connection; and
sending a first instruction to a telephone network associated with the first telephone line to forward calls intended for the first telephone line to the destination telephone line.

2. The method of claim 1, wherein the destination telephone line is the second telephone line.

3. The method of claim 1, wherein the destination telephone line is a third telephone line.

4. The method of claim 1, wherein the sensing and the sending are performed by the first telephone.

5. The method of claim 1, wherein the sensing and the sending are performed by the second telephone.

6. The method of claim 1, further comprising:
detecting an incoming call intended for the first telephone at the first telephone line; and
forwarding the incoming call to a destination telephone associated with the destination telephone line.

7. The method of claim 1, further comprising deactivating forwarding the incoming call when the first telephone is out of the vicinity of the second telephone.

8. The method of claim 1, wherein the first telephone line is a wireless telephone line.

9. The method of claim 1, wherein the second telephone line is a public switched telephone network telephone line.

10. The method of claim 1, wherein the destination telephone line is one of a public switched telephone network telephone line and a wireless telephone line.

11. The method of claim 1, further comprising:
sensing absence of the first telephone associated with the first telephone line within the vicinity of the second telephone associated with the second telephone line; and
sending a second instruction to the telephone network associated with the first telephone line to cancel the first instruction.

12. The method of claim 1, further comprising:
detecting an incoming call intended for the first telephone at the first telephone line; and
alerting the incoming call to the destination telephone at the destination telephone line.

13. The method of claim 1, wherein the sensing of the presence of the first telephone further comprising coupling the first telephone with the second telephone.

14. The method of claim 1, further comprising receiving the first telephone within a cradle of the second telephone.

15. A system for forwarding calls intended for a first telephone line to a destination telephone line, comprising:
a sensing circuit for sensing presence of a first telephone associated with the first telephone line within a vicinity of a second telephone associated with a second telephone line, wherein the vicinity is one of an RF range and a physical connection; and
an instruction circuit for sending an instruction to a telephone network associated with the first telephone to forward calls intended for the first telephone to a destination telephone associated with a destination telephone line.

16. The telephone system of claim 15, further comprising a deactivation switch configured to cancel the instruction.

17. The telephone system of claim 16, wherein the deactivation switch is configured to be closed manually by a user.

18. The telephone system of claim 15, further comprising a cradle associated with the second telephone for receiving the first telephone.

19. The telephone system of claim 15, wherein the first telephone line is a wireless telephone line.

20. The telephone system of claim 15, wherein the second telephone line is a public switched telephone network telephone line.

21. The telephone system of claim 20, wherein the destination telephone line is the second telephone line.

22. The telephone system of claim 15, wherein the destination telephone line is a third telephone line.

23. The telephone system of claim 22, wherein the third telephone line is one of a wireless telephone line and a public switched telephone network telephone line.

24. The telephone system of claim 15, wherein the sensing circuit is associated with the first telephone.

25. The telephone system of claim 15, wherein the sensing circuit is associated with the second telephone.

26. The telephone system of claim 15, wherein the instruction circuit is associated with the first telephone.

27. The telephone system of claim 15, wherein the instruction circuit is associated with the second telephone.

28. A method for forwarding telephone calls intended for a wireless telephone line to a public switched telephone network telephone, comprising:
detecting, by the public switched telephone network telephone, presence of the wireless telephone within a vicinity of the public switched telephone network telephone, wherein the vicinity is one of an RF range and a physical connection;
sending, by the public switched telephone network telephone, an instruction to a wireless telephone network associated with the wireless telephone to forward calls intended for the wireless telephone to the public switched telephone network telephone;
receiving a call intended for the wireless telephone by the wireless telephone network; and
forwarding the call by the wireless telephone network to the public switched telephone network telephone.

29. The method of claim 28, wherein each of the wireless telephone and the public switched telephone network telephone includes a BLUETOOTH transceiver.

30. A telephone comprising:
a sensor for detecting presence of a wireless telephone within a vicinity of the telephone, wherein the vicinity is one of an RF range and a physical connection, wherein the wireless telephone is associated with a wireless telephone network; and
a circuit for sending an instruction to the wireless telephone network to forward calls intended for the wireless telephone to a destination telephone associated with a second telephone network.

31. The telephone of claim 30, further comprises a cradle configured to receive the wireless telephone.

32. The telephone of claim 30, wherein the sensor is triggered when the wireless telephone is received in the cradle.

33. A cordless telephone comprising:
a base unit connected to a public switched telephone network telephone line;
a portable unit in communication with the base unit;
a sensor for detecting presence of a wireless telephone associated with a wireless telephone network within a range of the cordless telephone, wherein the sensor is housed within one of the base unit and the portable unit; and
a circuit for sending an instruction to the wireless telephone network to forward calls intended for the wireless telephone to the cordless telephone.

34. The cordless telephone of claim 33, wherein the base unit further comprises a cradle configured to receive one of the portable unit and the wireless telephone.

35. The cordless telephone of claim 33, wherein the base unit further comprises a first cradle configured to receive the portable unit and a second cradle configured to receive the wireless telephone.

36. The cordless telephone of claim 33, wherein the circuit is activated to send the instruction when the wireless telephone is received in a cradle of the base unit.

37. A telephone comprising:
a processor configured to send an instruction to a wireless telephone network to forward calls intended for a wireless telephone associated with the wireless telephone network to a destination telephone associated with a telephone network different from the wireless telephone network.

38. The telephone of claim 37, further comprising an activation switch in communication with the processor, wherein the activation switch is configured to be manually activated by a user of the telephone to trigger the processor to send the instruction.

39. A method for processing telephone calls, comprising:
sending a first instruction, by one of a wireless telephone and a public switched telephone network telephone to a wireless telephone network associated with the wireless telephone, to forward calls intended for the wireless telephone to the public switched telephone network telephone;
terminating, by the wireless telephone network telephone, a call intended for the wireless telephone at the public switched telephone network telephone;
receiving, by the public switched telephone network telephone, a user intervention to cancel the first instruction;
conveying, by the public switched telephone network telephone to the wireless telephone, the user intervention; and
sending a second instruction, by the wireless telephone to the wireless telephone network, to cancel the first instruction,
whereby all subsequent calls intended for the wireless telephone are terminated to the wireless telephone.

40. The method of claim 39, further comprising detecting, by one of the wireless telephone and the public switched telephone network telephone, presence of the wireless telephone within a vicinity of the public switched telephone network telephone.

41. The method of claim 39, further comprising closing of an activation switch before sending the first instruction.

42. The method of claim 39, wherein the vicinity is one of an RF range and a physical connection.

43. The method of claim 39, wherein the detecting the presence of the wireless telephone within the vicinity of the public switched telephone network telephone involves wireless communications between a first BLUETOOTH transceiver in the wireless telephone and a second BLUETOOTH transceiver in the public switched telephone network telephone.

44. The method of claim 39, wherein the receiving the user intervention to cancel the first instruction involves closing of a deactivating switch by a user.

45. The method of claim 39, wherein the conveying the user intervention is performed by the public switched network telephone using one of RF communication and a physical connection.
